(19) United States
(12) Patent Application Publication
(10) Pub. No.: US 2007/0072576 A1
(43) Pub. Date: Mar. 29, 2007

(54) Passive mixer

(76) Inventors: Henrik Sjoland, Loddekopinge (SE); Fredrik Tillman, Lund (SE)

Correspondence Address: POTOMAC PATENT GROUP, PLLC, P. O. BOX 270, FREDERICKSBURG, VA, 22404, US

(21) Appl. No.: 10/549,692

(22) PCT Filed: Mar. 15, 2004
(86) PCT No.: PCT/EP04/02654

§ 371 Date: Jun. 23, 2006

Related U.S. Application Data
(60) Provisional application No. 60/459,504, filed on Apr. 1, 2003.

(30) Foreign Application Priority Data
Apr. 1, 2003 (EP) 03007555.0

(51) Int. Cl. H04B 1/26

(52) U.S. Cl. 455/323

(57) ABSTRACT

A passive mixer for converting a radio frequency (RF) signal to an intermediary frequency (IF) signal or vice versa. The mixer comprises a voltage controlled mixing means for mixing a local oscillator signal with either an RF or IF signal. A bootstrapping technique is used for feeding back a low frequency component of the IF signal through a low-pass filter to the mixing means. The mixing means will follow low frequency variations of the IF signal, which will improve the linearity of the mixer.

### TECHNICAL FIELD OF THE INVENTION

The present invention relates to a passive mixer, and more particularly toga passive mixer having a configuration for improved linearity.

### DESCRIPTION OF RELATED ART

A mixer for converting a signal having a first frequency, such as radio frequency (RF), to a signal having a second frequency, such as an intermediary frequency (IF), is provided in a wide variety of implementations, such as in radio transceiver front-ends. Bluetooth® is a communication standard where the major goal has been to remove cable connections between electrical equipment. One area, where Bluetooth® is of particular interest, is communication involving portable equipment, such as mobile terminals. The terminals may also be adapted to communicate according to e.g. a telecommunication technology, such as GSM, UMTS, cdma2000, PCS, DCS etc. A mixer may be necessary for the radio transceiver front-end of the Bluetooth® radio and the telecommunication radio.

In portable communication equipment, low power solutions for all electronic components are important. Thus, the tendency in integrated circuit design is to apply low supply voltage for e.g. the mixer. Also, it is often required that the implementation of the mixer is cheap. MOS (Metal Oxide Semiconductor) technology offers a solution, with which is possible to implement fully integrated mixers. However, it is essential to find circuit architectures capable of high performance at supply voltages at or below 2V.

Frequency translation using mixing means can be provided in either the current or the voltage domain using a non-linear transfer. However, mixing can also be achieved by applying multiplication in the time domain. In such a case the mixer can be viewed as a two-state machine, wherein the mixer should be as linear as possible in each state. This type of mixer represents a linear time-variant system.

The switching from a conducting to a non-conducting state of a mixing means can be provided in either the current or the voltage domain. In case of bipolar technology, the current switching is superior. The MOSFET (Metal Oxide Semiconductor Field Effect Transistor) transistor offers true voltage switch characteristics. Thus, it is feasible to perform the switching in the voltage domain for the MOSFET transistor.

Integrated analog circuits will in the future be driven by lower supply voltages than today due to the CMOS (Complementary MOS) technology scaling and the system-on-chip trend, wherein a radio transceiver is provided on a single chip. This trend will enforce shared technology between the digital and analog domain, making low voltage implementations necessary. In the receiver front-end, one major bottleneck is the linearity of the down-converting mixer. This is particularly the case for low supply voltages, even if a suitable topology is used, such as the passive CMOS mixer.

In operation, a MOSFET transistor is conducting when the gate-source voltage V_{gs} becomes larger than the threshold voltage V_{T}. A transistor receiving a RF signal on either its drain or source terminal may provide a varying source, or drain, node potential. Said potential will vary in dependence of a signal provided on the gate input terminal, which often times is a local oscillator (LO) signal. Also, a RF leakage may occur. The critical signal is the intermediary frequency (IF) signal provided on the source/drain terminal, which will modulate the on-time of the switch and cause non-linearity. A MOSFET transistor switch operating in either the off state or as a triode (on state), will be controlled not only by the gate voltage, but also by the source voltage. Consequently the IF output signal provided at the source/drain will modulate the switch duty cycle and generate intermodulation products. This is especially severe for low supply voltages, which limit the achievable LO amplitude.

A common way to reduce the switch non-linearity is to use a complementary switch known as a transmission gate. However, such a switch will increase the load capacitance of a low noise amplifier (LNA), which often precedes the mixer of a receiver, resulting in lower conversion gain and smaller bandwidth. Furthermore, if the mixer is balanced, the complementary switch will only effect even order non-linearity.

### SUMMARY OF THE INVENTION

One object of the present invention is to provide a mixer having improved linearity compared to equivalent mixers known in the art. More specifically, it is an object of the invention to provide a mixer having improved linearity at low supply voltage, which may be implemented as an integrated circuit using on chip implementation technology, such as MOS (Metal Oxide Semiconductor) or JFET (Junction Field Effect Transistor) technology.

According to one aspect of the invention, the above objects are achieved by a passive mixer for converting a first signal having a first frequency to a signal having a second frequency. The mixer comprises mixing means, a first terminal, a second terminal, and a third terminal, for providing the second signal by mixing a third signal having a third frequency provided as input at the second terminal and the first signal provided as input at either the first or the third terminal. The second signal is provided as output at the terminal not receiving any input signal. A feedback circuit is operatively connected to the third terminal and the second terminal.

The feedback circuit may be a bootstrap circuit. Furthermore, the feedback circuit may comprise a low-pass filter. Said filter may be a first order filter provided by a resistor and a capacitor.

The mixing means may be a voltage controlled switch, such as a FET transistor switch having either its drain or source operatively connected to the first terminal, its gate operatively connected to the second terminal, and either its source or drain operatively connected to the third terminal. The FET transistor may be a NMOS transistor having superior switch performance compared to a PMOS transistor.

The mixer may be provided as a balanced or non-balanced mixer. A balanced mixer may comprise four mixing means, wherein each of said means comprises a bootstrap circuit.

According to another aspect of the invention, the mixer is used in electronic equipment, such as a portable communication equipment. Portable equipment comprises, but is not limited to, a mobile radio terminal, a mobile telephone, a pager, or a communicator, i.e. a personal digital assistant, a smartphone, etc. The mixer may also be used in electronic equipment for communication in a wireless local area network, such as equipment adapted for short-range supplementary communication, e.g. according to Bluetooth® technology.

An advantage of the present invention is that no DC current flows through the mixing means. The absence of any DC current will reduce the 1/f noise of the mixer. The topology of the invention combined with MOS technology has the advantage that it is suitable for low voltage implementations, such as approximately 2V and below, as a MOS circuit does not use stacked transistors. As the supply voltage will be further decreased in the future the invention will become even more important. Furthermore, the invention improves the linearity compared to mixers known in the art without sacrificing other important parameters, such as noise performance and conversion gain.

Further preferred embodiments of the invention are defined in the dependent claims.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Further objects, features, and advantages of the invention will appear from the following description of several embodiments of the invention, wherein various aspects of the invention will be described in more detail with reference to the accompanying drawings, in which:

FIG. 1 is a front view of a mobile telephone and the environment in which it may operate;

FIG. 2 is a block diagram of the mixer according to the invention;

FIG. 3 is a block diagram of a first embodiment of the mixer according to the invention;

FIG. 4 is a block diagram of a second embodiment of the mixer according to the invention; and

FIG. 5 is a diagram illustrating measurement results of the mixer of FIG. 4.

### DETAILED DESCRIPTION OF EMBODIMENTS

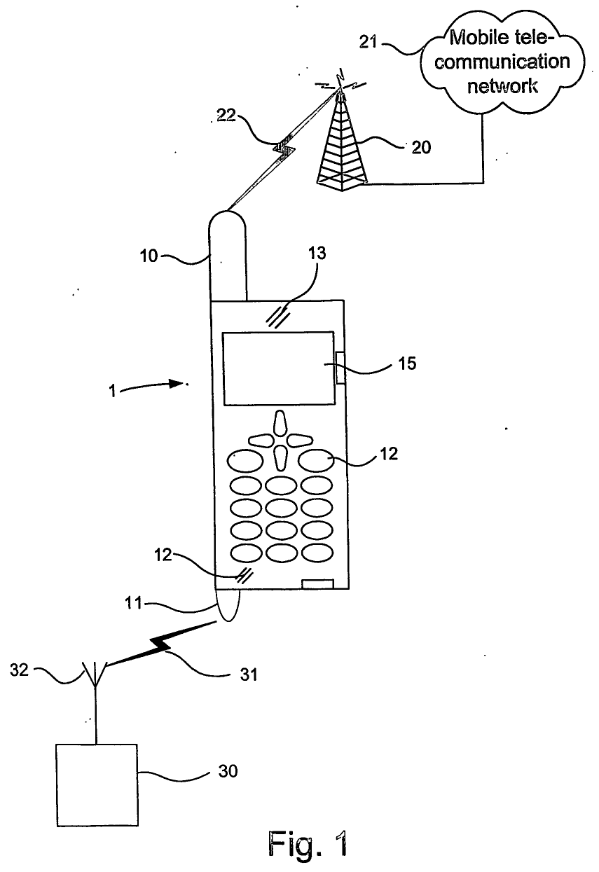

FIG. 1 illustrates a mobile telephone 1 as one exemplifying electronic equipment, in which the mixer according to the present invention may be provided, and a possible environment in which it operates. The invention is not limited to a mobile telephone 1 but can be provided in a wide variety of electronic equipment wherein a mixer is required for converting a first signal having a first frequency, such as an intermediary frequency (IF) or a radio frequency (RF), to a second signal having a second frequency, such as a RF or a an IF frequency, by means of a third signal having a third frequency generated by e.g. a local oscillator (LO). The mobile telephone 1 comprises a first antenna 10 and a second auxiliary antenna 11. A microphone 12, a loudspeaker 13, a keypad 14, and a display 15 provide a man-machine interface for operating the mobile telephone 1.

The mobile telephone may in operation be connected to a radio station 20 (base station) of a mobile communication network 21, such as a GSM, UMTS, PCS, and/or DCS network, via a first radio link 22 by means of the first antenna 10. Furthermore, the mobile telephone 1 may in operation establish a second wireless link to a peripheral device 30 via second wireless link 31 by means of the auxiliary antenna 11. The second link 31 is e.g. a Bluetooth® link, which is established in the 2.4 (2.400-2.4835) GHz frequency range. To establish the wireless links 22, 31, the mobile telephone 1 comprises radio resources, which are adapted according to the relevant technologies. Thus, the mobile telephone 1 comprises one radio access means, such as a transceiver, for communicating with the base station 20, and one radio access means for communicating with the peripheral device 30.

The peripheral device 30 may be any device having wireless communicating capabilities, such as according to Bluetooth® technology or any other wireless local area network (WLAN) technology. It comprises an antenna 32 for exchanging signals over the second link 31, and a transceiver (not shown) adapted according to the communication technology that the peripheral device 30 uses. The device may be a wireless headset, a remote server, a fax machine, a vending machine, a printer etc. A wide variety of electronic equipment may have such communication capabilities and have a need for wirelessly transferring of data.

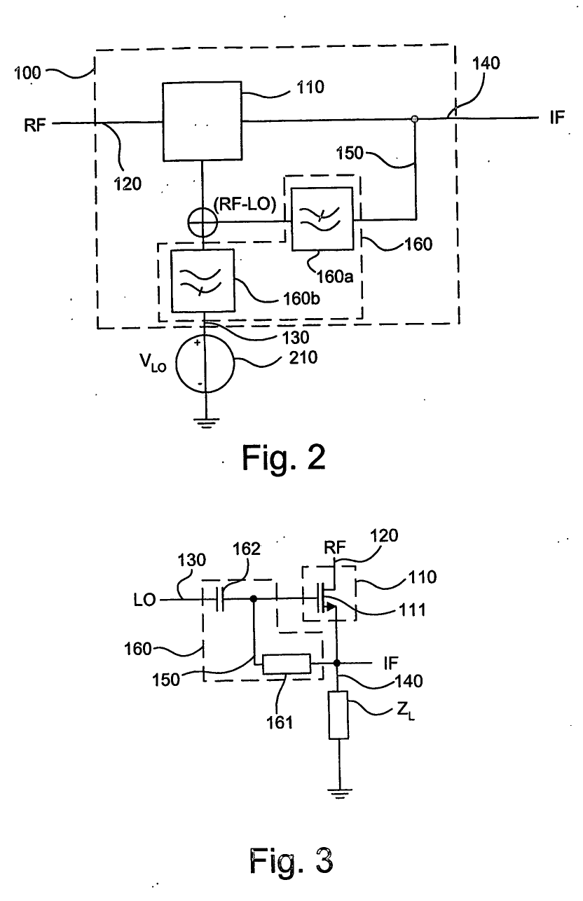

FIG. 2 is a block diagram of a passive mixer 100 according to the invention. The mixer 100 is a frequency-translating mixer for down-converting radio frequency (RF) signal to an intermediary frequency (IF) signal.

Alternatively, the mixer 100 up-converts an IF signal to an RF signal. The mixer 100 comprises a mixing means 110, a first terminal 120, a second terminal 130, and a third terminal 140. At the first terminal 120 will a RF signal either be an input signal (in a receiver mixer) or an output signal (in a transmitter mixer). At the third terminal 140 there will be provided an IF signal, which can either be an input signal (in a transmitter mixer) or an output signal (in a receiver mixer). At the second terminal 130 there will be provided a local oscillator (LO) signal, which has a frequency for converting either the IF signal or the RF signal.

The second terminal 130 is operatively connected to a voltage supply 210 being a local oscillator (LO), which provides a signal having a third frequency suitable for providing the RF or IF signal. The voltage supply 210 is referenced to grounding means, such as the substrate on which it is provided. A high pass filter component 160b may be provided in the signal path between the second terminal 130 and the mixing means 110, said high pass filter component passes the high frequency signal from the voltage supply 210 to the mixing means and prevents low frequency signals from the third terminal 140 to enter the voltage supply 210.

The mixer 100 further comprises a feedback circuit 150 connected to the third terminal 140 to the connection between the high pass filter component 160b and the mixing means 110. The feedback circuit 150 may comprise a feedback filter 160 (low-pass filter) for allowing low-frequency signals from the third terminal to be fed back. Said feedback filter 160 comprises a low-pass filter component 160a, which passes low-frequency signals from the third terminal to the mixing means 110, and the high-pass filter component 160b for passing high frequency signals from the voltage supply 210.

FIG. 3 illustrates one embodiment of the mixing means 110 and the feedback filter 160 for a receiver or a transmitter radio front-end. The mixing means 110 comprises a FET transistor 111, such as a MOSFET, having its drain connected to the first terminal 120, its gate operatively connected to the second-terminal 130 via a capacitor 162, and its source connected to the third terminal 140. As the MOSFET transistor is symmetrical, the drain and source, whenever mentioned in this description, may be interchanged.

The mixing means 110 provides a voltage switch for providing mixing of the RF signal and the LO signal, or mixing of the IF signal and the LO signal. The MOS transistor 111 has true voltage switch characteristics. Therefore, it is possible to provide switching in the voltage domain. This makes it possible to reduce the DC current flow through the transistor 111, and thereby avoid the 1/f noise which would be a problem especially for direct conversion and low IF-receiver characteristics.

In the embodiment of FIG. 3 the transistor 111 is provided as a field effect transistor (FET), such as a NMOS transistor. The NMOS transistor has better switch performance than the PMOS transistor due to the better mobility of electrons than holes. However, the transistor may alternatively be provided using a PMOS transistor Other voltage controlled switches, such as the juncti [symbol] field effect transistor (JFET) may still alternativel [symbol] utilized as the mixing means.

To take care of the non-linearity problem of th [symbol] prior art, the feedback circuit 150 will cause the ga [symbol] voltage to follow the low frequency output potential [symbol] variations. The feedback filter 160 is adapted to pa [symbol] low-frequency difference-component (RF−LO) of the IF [symbol] signal, and filter out a high frequency addition comp [symbol] (RF+LO) of said IF signal. The low-frequency compone [symbol] be fed to the gate of the transistor 111, which will modulated by the low frequency component of the IF s [symbol] together with the LO signal. By providing the bootst [symbol] feedback circuit 150, the transistor will be indepen [symbol] the high-frequency component of the IF signal, which [symbol] the mixer 100 more linear. The switching instant of [symbol] transistor 111, i.e. when the transistor switches fr [symbol] non-conducting to a conducting state, is dependent c [symbol] gate-source voltage V_{gs}. If the IF signal at the sou [symbol] electrode Vₛ varies, V_{gs} will vary. The feedback cir [symbol] makes the overdrive voltage, which is dependent on [symbol] independent of the IF signal. The feedback filter [symbol] also prevent LO to IF leakage.

The feedback filter 160 may be provided in a [symbol] ways. In FIG. 3, a first order filter is provide [symbol] a resistor 161 and a capacitor 162. The capacitor [symbol] connected between the second input terminal 130 and transistor gate. The resistor 161 is connected betw [symbol] third terminal 140 and the connection between the c [symbol] 162 and the transistor gate. Alternative filter sol [symbol] may be higher order passive filters or active filte

[symbol]

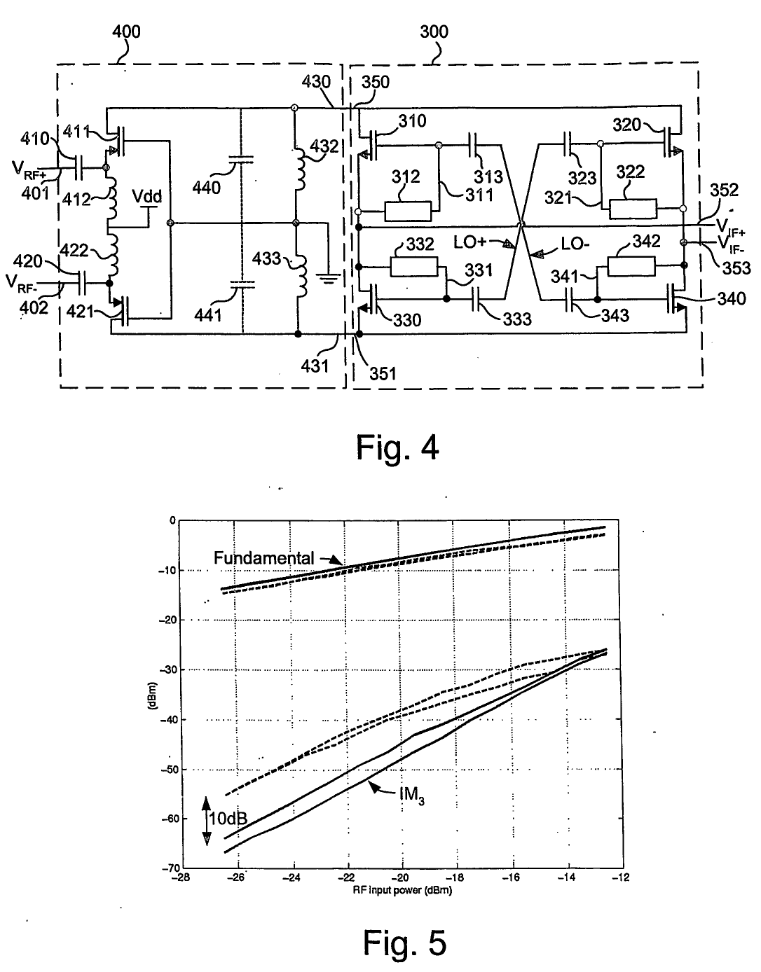

FIG. 4 illustrates an embodiment wherein the [symbol] invention comprises a passive balanced mixer 300 fo [symbol] converting an IF signal having an even number of [symbol] transistors. The mixer 300 is connected to a low noise amplifier (LNA) stage 400 providing the RF signal. In this implementation, the RF signal and the IF signal are differential signals. However, the IF and RF signals may alternatively be single ended. The balanced mixer is desired for on chip implementation as it provides less disturbance (noise) and cancellation of even and odd non-linearity. The balanced mixer 300 may also be implemented in a transmitter for up-converting an IF signal. The mixer 300 comprises in this embodiment four mixing means 310, 320, 330., 340. Said mixing means have essentially the same configuration as the mixing means disclosed in Fig. 3. Consequently, each transistor 310, 320, 330, 340 is provided as a FET transistor. The feedback circuits 311, 321, 331, 341 are connected between source and gate of the first and second transistors 310, 320, and between gate and drain of the third and fourth transistors 330, 340, respectively. Also-, filters are provided by resistors 312, 322, 332, 342 and capacitors 313, 323, 333, 343. The balanced mixer 300 comprises first and second terminals 350, 351 for receiving (or providing in the case of a transmitter-mixer) an RF signal. The capacitor 313 connected to the first transistor 310 is also connected to the capacitor 343 connected to the fourth transistor 340. At the connection between said capacitors 313, 343 a negative LO or translation signal, LO⁻, is provided, which has a required frequency for frequency translating an input RF signal. Thus the input terminals of the filter capacitors 313, 323, 333, 343 correspond to the second terminal 130 of FIG. 3. The capacitor 323 connected to the second transistor 320 is also connected to the capacitor 333 connected to the third transistor 330. The source of the first transistor 310 is connected to the drain of the third transistor 330. The source of the second transistor 320 is connected to the drain of the fourth transistor 340. At the connection between said capacitors 323, 333, there is provided a positive LO or translation signal, LO⁺, which has a required frequency for frequency translating a RF signal. A positive output terminal 352 is connected to the source of the first transistor 310 and the drain of the third transistor 330, for providing a positive IF signal, V_{IF+}. A negative output terminal 353 is connected to the source of the second transistor 320 and the drain of the fourth transistor 340, for providing a negative IF signal, V_{IF-}. The output terminals 352, 353 will be input terminals when the mixer is provided in a transmitter.

The LNA 400 comprises first and second input terminals 401, 402 for receiving a differential input RF signal V_{RF+} and V_{RF-}, respectively. The first input terminal 401 is connected to a capacitor 410 being connected to the source of a first LNA transistor 411 providing a first amplifying means. Said source is also operatively referenced to supply, Vdd, via an inductor 412. The gate of the first LNA transistor 411 is referenced to grounding means. The second input terminal 402 is connected to a capacitor 420 being connected to the source of a second INA transistor 421 providing a second amplifying means. Said source is also operatively referenced to supply, Vdd, via a second inductor 422. The gate of the second LNA transistor 421 is referenced to grounding means. The drain of the first LNA transistor 411 is connected to a positive output terminal 430, and the drain of the second LNA transistor 421 is connected to a negative output terminal 431. Third and fourth inductors 432, 433 are provided between grounding means and the LNA output terminals 430, 431, respectively. The output terminals 430, and 431 of the LNA 400 are connected to the input terminals 350, and 351 of the mixer 300, respectively.

The LNA 400 is arranged as a common gate configuration, which provides a broadband matching for the differential input. A common gate configuration is used to achieve a 50Ω input matching. The input resistance is approximately 1/gₘ, where gₘ is the transconductance of the LNA transistors 411, 421. In the embodiment of FIG. 4, PMOS transistors are chosen as the LNA transistors 411, 421 for biasing reasons. Since the LO signal provided by the mixing means 300 shown in FIG. 4 will have a maximum voltage swing from ground to 2V, for a voltage supply of 1V, it is best for the NMOS transistors 310, 320, 330, 340 of the mixing means 300 to have a DC output level equal to zero, as set out above. This will maximize the gate-source voltage, which is important for the mixer noise and linearity. The LNA transistors 411, 421 are biased by the inductors 412, 422, which maximizes the signal level that can be handled at the output, resulting in improved linearity. Due to the inductors 432, 433 at the output terminals 430, 431, these nodes will be able to reach negative voltages down to the knee voltage of the drain diodes of the transistors 310, 320, 330, 340 of the mixing means 300. Parallel with the third and fourth inductors 432, 433 there will be parasitic capacitances 440, 441 present, as is illustrated with dotted lines.

In one exemplifying embodiment of the invention, the mixing means 300 and LNA 400 are designed for a fully integrated 1V 0.25 μm CMOS 2.4 GHz Bluetooth® radio front-end for low IF. The sizing of the components of the mixing means 300 are:

| | |
|---|---|
| Resistors | 1 kΩ; |
| Capacitors | 1 pF; and |
| transistors | width 50 μm, |
| | length 0.25 μm. |

The sizing of the components of the LNA 400 are:

| | |
|---|---|
| capacitors | 1 pF; |
| bias inductors | 7 nH; |
| output inductors | 6 nH; |
| parasitic capacitance | 100 fF; and |
| transistors | length 350 μm |
| | width 0.25 μm. |

The measurement-results of the circuit of FIG. 4 are depicted in FIG. 5. The linearity was measured with a two-tone test with a LO frequency equal to 2.467 GHz, in IF fundamental at 7 MHz and an IM₃ (third-order intermodulation product) at 6 MHz. The results are plotted in FIG. 5, wherein the measurement results of the inventive mixer are shown with a solid line and the results of an equivalent mixer without bootstrapping are shown with a dashed line. As can be seen from the graph, the front-end using bootstrapping according to the invention has an IM₃ lowered by about 10 dB, which results in an IIP3 (third order input intercept point) improved by 5 dB. At the same time, the fundamental IF of the front end using bootstrapping is slightly better than for the front-end without.

The exemplifying sizing of the mixer 300 and LNA 400 of FIG. 4 should not be taken as limiting the scope of the invention. The invention may be provided in a wide variety of implementations, wherein the sizing of the circuit has to be tested and evaluated in each particular case.

In the above, reference has been made to RF and IF frequencies. However, the invention is not limited to RF and IF frequencies, but can be used in any configuration wherein a first signal having a first frequency is to be converted to a second signal having a second frequency.

The present invention has been described above with reference to specific embodiments. However, other embodiments than the above described are equally possible within the scope of the invention. The different features of the invention may be combined in other combinations than those described. The invention is only limited by the appended patent claims.

1. A passive mixer for converting a first signal having a first frequency to a second signal having a second frequency, comprising:
mixing means, a first terminal, a second terminal and a third terminal, for providing the second signal by mixing a third signal having a third frequency provided as input at said second terminal and the first signal provided as input at either the first or the third terminal; and
a feedback circuit operatively connected to said third and said second terminal.

2. The mixer according to claim 1, wherein the feedback circuit is a bootstrap circuit.

3. The mixer according to claim 1, wherein the feedback circuit comprises a low pass filter.

4. The mixer according to claim 3, wherein the filter comprises a capacitor connected between said second terminal and said mixing means, and a resistor connected between said third terminal and the connection between said capacitor and said mixing means.

5. The mixer according to claim 1, wherein said mixing means is a voltage controlled switch.

6. The mixer according to claim 1, wherein said mixing means comprises a FET transistor switch having either its drain or source operatively connected to said first terminal, its gate operatively connected to said second terminal, and either its source or drain operatively connected to said third terminal.

7. The mixer according to claim 6, characterized in that said FET transistor is an NMOS transistor.

8. The mixer according to claim 1, wherein the mixer is a balanced mixer comprising an even number of mixing means.

9. The mixer according to claim 1, wherein the mixer is included in electronic equipment.

10. The mixer according to claim 9, wherein the electronic equipment is a portable communication equipment having a supply voltage of less than 2V.

11. The mixer according to claim 9, wherein the electronic equipment is a mobile radio terminal, a mobile telephone, a pager, or a communicator.

12. The mixer according to claim 9, wherein the electronic equipment is adapted to operate in a wireless local area network.

13. The mixer according to claim 9, wherein the electronic equipment is communication equipment adapted to provide short-range supplementary communication according to Bluetooth® technology.

14. Apparatus comprising:
a mixer; and
a low noise amplifier,
wherein:
the mixer comprises:
mixing means, a first terminal, a second terminal and a third terminal, for providing the second signal by mixing a third signal having a third frequency provided as input at said second terminal and the first signal provided as input at either the first or the third terminal; and
a feedback circuit operatively connected to said third and said second terminal;
the mixer is connected to the low noise amplifier; and
the low noise amplifier comprises:
a first input terminal connected to a first capacitor being connected to a first amplifying means, said first amplifying means is connected to a first output terminal and to voltage supply via a first inductor;
a second input terminal connected to a second capacitor being connected to a second amplifying means, said second amplifying means is connected to a second output terminal and to voltage supply via an second inductor; and
wherein the first and second amplifying means are referenced to grounding means, and the first and second output terminals are referenced to said grounding means via third and fourth inductors.
